(19) United States
(12) Patent Application Publication
(10) Pub. No.: US 2005/0086344 A1
(43) Pub. Date: Apr. 21, 2005

(54) Method and system for unrestricted, symmetric remote scripting

(75) Inventor: Michael F. Suesserman, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: eAxis, Inc., Seattle, WA (US)

(21) Appl. No.: 10/966,757

(22) Filed: Oct. 14, 2004

Related U.S. Application Data
(60) Provisional application No. 60/511,567, filed on Oct. 15, 2003.

(51) Int. Cl. G06F 15/16

(52) U.S. Cl. 709/227; 709/203

(57) ABSTRACT

A system and method is provided for unrestricted, symmetric remote scripting. A client-based application transmits a request to a serve application. The server application processes the request and transmits a response including an instruction for contacting the server application. The client application processes the response and utilizes the included instruction to establish a persistent connection with the server application. The invention may be utilized for a variety of functions.

### CROSS-REFERENCE TO RELATED APPLICATION

This application claims the benefit of U.S. Provisional Application No. 60/511,567, filed Oct. 14, 2003, which is incorporated by reference herein.

### FIELD OF THE INVENTION

The present invention relates in general to network-based programming methods and systems. In particular, the invention relates to methods and systems for remote scripting in a networked client/server environment.

### BACKGROUND OF THE INVENTION

In the most general sense, Remote Scripting is a process by which a client-side application (such as a web browser) and a server-side application can exchange data without having to reload part or all of a client page. This remote scripting capability is very useful for a broad range of client/server applications. The most common use for remote scripting is to perform a Remote Procedure Call (RPC) where a client essentially runs a block of code on a remote server and then receives a response from the server with any resulting data and instructions generated by the server code that was run. In all cases, remote scripting significantly reduces the bandwidth of data that is transferred between a client and server largely by eliminating many of the full client page reloads that would be needed without remote scripting. At present, three general ways to implement remote
Microsoft Remote Scripting (MSRS)
JavaScript Remote Scripting (JSRS)
Specialized Client Applications (Java, ActiveX, Flash, XML-RPC, etc.)
   Microsoft Remote Scripting (MSRS)

Microsoft Remote Scripting (MSRS) consists of three separate pieces of code: client-side JavaScript, server-side code, and an invisible client-side Java applet. The client-side Java applet handles communication with the server, and the client-side JavaScript communicates with the invisible applet. The server-side code receives a request from the Java applet, processes the request, and returns the result to the applet. The client/server communication uses simple HTTP GET with details of the method call and parameters passed as name/value pairs as part of the query (a third party add-on allows HTTP POST to be used with MSRS). Generally described, MSRS involves the following actions:

1. The browser executes a JavaScript call to the invisible Java applet.

2. The remote scripting applet uses HTTP GET to access a URL on the server.

3. The server returns its response and the applet receives it.

4. The response is interpreted by the remote scripting applet and then returned to the calling JavaScript code.

JavaScript Remote Scripting (JSRS)

JSRS works by using JavaScript to inject a hidden <IFRAME> HTML element (or <LAYER> element in some old browsers) for each remote scripting call. The hidden element is navigated to the remote scripting URL using an HTTP GET (by using JavaScript to set the hidden element's SRC attribute); with an<IFRAME> it is possible to use JSRS to perform an HTTP POST by dynamically adding form elements to the <IFRAME>. The result returned by the server is generally HTML that includes a JavaScript on Load call to the main window callback function. Generally described, JSRS involves the following actions:

1. The browser executes a JavaScript call to the hidden <IFRAME> or <LAYER> element.

2. Create (or reuse) an<IFRAME> or <LAYER> element and navigate it (perform an HTTP GET) to a URL on the server.

3. The server returns its response and the hidden element on the client receives it.

4. The <BODY> on Load of the returned HTML invokes the JavaScript callback with the returned value.

Numerous specific variations of JSRS have been used in practice. For example, “One-way Communication” JSRS generally involves using JavaScript to set the SRC attribute of an invisible image (zero pixels). The effect is to send an HTTP GET to a remote server with some data from the client. However, since an image is returned as the HTTP response, the client does not actually receive any useful response data from the server (i.e., one way communication from the client to server). This one-way JSRS approach is very common for tracking site users and for confirming that a customer viewed an HTML email ad.

Specialized Client Applications

Specialized client technologies (Java, ActiveX, Flash, XML-RPC, etc.) are able to make HTTP server requests and to interact with client-side JavaScript. Therefore, by embedding these client technologies into a web page, it is possible to implement the client component of a remote scripting system. Although these specialized clients offer fairly powerful processing and networking capabilities, their support across browsers and operating systems is very variable, unreliable, and unpredictable.

Although all the above mentioned methods can be used for remote scripting, none offer an ideal solution and in practice each approach suffers from at least one major limitation or weakness. Clearly, a significant technical and commercial need exists for a remote scripting technology or method that can eliminate some or all the technical issues with existing remote scripting methods.

### SUMMARY OF THE INVENTION

A system and method is provided for unrestricted, symmetric remote scripting. A client-based application transmits a request to a serve application. The server application processes the request and transmits a response including an instruction for contacting the server application. The client application processes the response and utilizes the included instruction to establish a persistent connection with the server application. The invention may be utilized for a variety of functions.

In accordance with an aspect of the present invention, a method for creating a network connection between a network-connected application and a server is provided. The method includes a server obtaining a network request from the network application. The server transmits to the network application information corresponding to the network request. The information includes at least one instruction for transmitting a subsequent request to the remote server. The server then receives a subsequent network request from the network application corresponding to the at least one instruction and establishes a persistent connection with the network application.

In accordance with another aspect of the present invention, a method for creating a network connection between a browser and a server is provided. The method includes a server obtaining a connection request from the browser. The server transmits to the browser information corresponding to the network request. The information includes information for transmitting a subsequent connection request to the remote server. The server obtains a subsequent connection request from the browser corresponding to the information for transmitting a subsequent connection request to the remote server. Additionally, the server establishes a persistent connection with the browser.

In accordance with a further aspect of the present invention, a system for producing a persistent network connection between any network-connected web browser (Browser) and any remote server (Server) is provided. The system includes a Browser that sends a dynamically generated HTTP GET request to the Server. The Browser includes a first executable code portion loaded on the Browser that includes Browser scripting code and a second executable code portion loaded on the Browser that generates and sends server connection requests. The source attribute of the second executable code portion is dynamically set. The system also includes a Server that receives and processes the network request from the Browser. The Server generates a response that returns to the second executable code portion data and at least one instruction to process the Browser request. Additionally, the Server response also includes an instruction that causes the Browser to send a subsequent request to the Server.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of an architecture for implementing unrestricted, symmetric remote scripting in accordance with an aspect of the present invention;

FIG. 2 is a block diagram of an architecture for implementing unrestricted, symmetric remote scripting illustrating client to server data transfer in accordance with an aspect of the present invention

### DETAILED DESCRIPTION OF THE PREFERRED EMBODIMENT

Generally described, the present invention relates to a remote scripting approach that allows for persistent client/server connections. More specifically, the present invention utilizes JavaScript (or any other client-side scripting or programming technology) from a “code” script to dynamically load a “data transfer” script for each remote scripting call. The “data transfer” script performs an HTTP GET when its SRC (source) attribute is set by the JavaScript code. The server returns the script contents, which can include any amount of server generated data, server generated JavaScript functions, and server generated RPC (Remote Procedure Call) calls that can call any client-side JavaScript function. Since the client loads the server response as a script, the response immediately runs as a new client-side script as soon as the client receives it. In accordance with an embodiment of the present invention, two distinct <SCRIPT> elements are used: one for the client-side code (referred to as the “code” script) and one for transferring data (including RPCs, etc.) between the client and server (referred to as the “data transfer” script).

An example of the two <SCRIPT> elements that implement the present invention is as follows:
<SCRIPT id=“usrsDataTransferScript” language=“JavaScript”></SCRIPT>
<SCRIPT id=“usrsCodeScript” language=“JavaScript” SRC=“usrsCode.js”></SCRIPT>.
   where the first <SCRIPT> element (id=“usrsDataTransferScript”) is the “data transfer” script, the second <SCRIPT> element (id=“usrsCodeScript”) is the “code” script, and the actual JavaScript code is loaded from a separate file (usrsCode.js). Loading the JavaScript code from a separate file makes it easier to manage the client code. Alternatively, the code could also be directly hard-coded within the <SCRIPT> tags for the “code” script.

This present invention offers a great deal of flexibility for how a site can enable its functionality. The two “dual script”<SCRIPT> elements can easily be hard-coded into the HTML of a web page at design time (static site) or run time (dynamic site). Alternatively, the “dual script” elements can be dynamically generated and added to a web page in real-time when the page loads (or in response to any event) in a browser.

Another approach for enabling is to dynamically add client activation code (such as the “dual script” elements) to every web page within a controlled network (such as a wireless or WiFi network, a corporate intranet or extranet, a broadband connection like DSL or cable, a modem, etc.). This controlled-network activation injection approach allows the present invention to control and interact with any client (browser or any web-enabled device) that loads any web page from within the controlled network. Since the present invention does not need to use any specialized clients, the invention can work on a number of web-enabled devices that support HTML and JavaScript (or any other client-side scripting or programming technology) including desktop computers, notebook computers, PDAs, wireless devices, etc.

In an illustrative embodiment, the present invention is similar to the JSRS (JavaScript Remote Scripting) method except that a <SCRIPT> element is used in place of an<IFRAME> element. A “dual script” approach creates a very efficient communication stream between a client and a server that for the first time produces a Remote Scripting method that can eliminate one or more of the limitations of existing Remote Scripting methods or technologies.

In some embodiments, the present invention works by using JavaScript (or any other client-side scripting or programming technology) from the “code” script to dynamically load the “data transfer” script for each remote scripting call. The “data transfer” script performs an HTTP GET when its SRC attribute is set by the JavaScript code, and the server returns the script contents, which can include any amount of server generated data, server generated methods, and server generated RPC calls that can call any client-side method. Since the client loads the server response as a script, the response immediately runs as a new client-side script as soon as the client receives it, which produces a very efficient communication channel between the client and server.

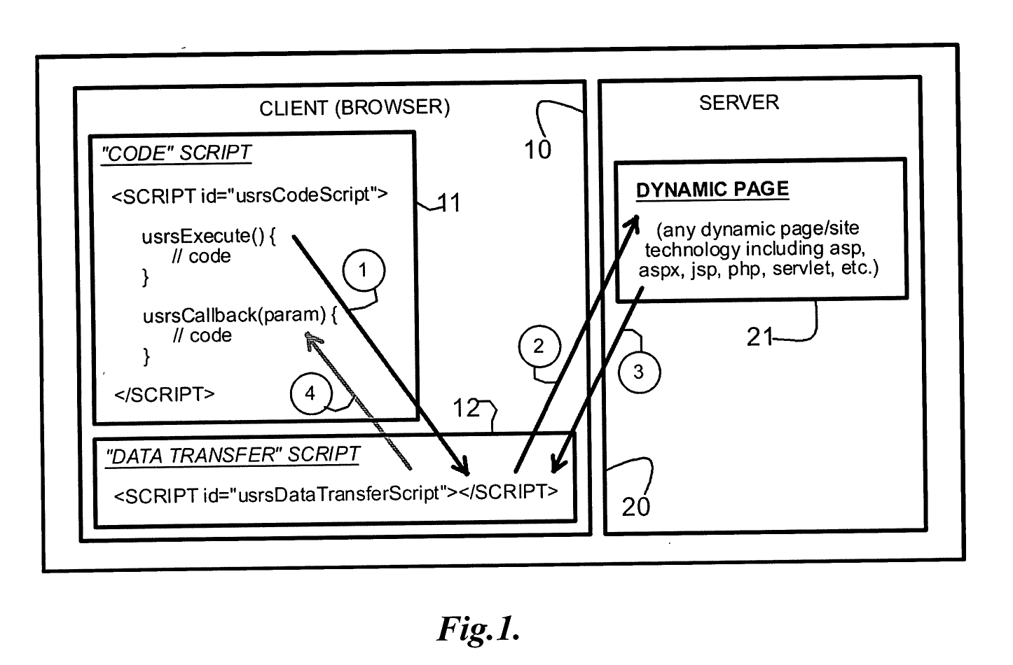

FIG. 1 is a block diagram illustrative of an architecture for implementing unrestricted, symmetric remote scripting in accordance with an embodiment of the present invention. As illustrated in FIG. 1,

1. The client (10) executes a JavaScript (11) call to usrsExecute, which sets the SRC attribute of the “data transfer” script (12) to the correct server URL (including any data that is added to the query string).

2. The “data transfer” script (12) sends a request (using HTTP GET) to a dynamic server page (21) on a server (20).

3. The dynamic server page (21) processes the client request and returns the “data script” (12) response formatted as JavaScript code. As soon as the client (10) receives the server (20) response, the client (10) immediately processes it as a new client-side script.

4. The server (20) response contains JavaScript code that runs as a new “data transfer” (12) script on the client (10). The server (20) response can contain any needed combination of JavaScript variables with server data, server generated JavaScript functions and calls, and a call to a callback function that continues some pending or new processing in the client-side “code” (11) script.

In accordance with an aspect of the present invention, two steps are generally followed to use the present invention for sending any amount of data from the client to a server:

Step 1) Determine the maximum amount of data that can be sent from a client to a server.

Step 2) Use an automated loop to send data from a client to a server in blocks that are no bigger than the maximum allowed by the client.

Before an unlimited amount of data can be sent from a client to a server, the maximum amount of data that can actually be sent from a client to a server is determined (either directly measured or assumed based on published browser specs). In an illustrative embodiment of the present invention, the maximum size of a URL in an HTTP GET depends on both the browser and the server but generally is just over 2 kB (2048 bytes) for IE 4.0+ browsers and over 5 kB for NETSCAPE and Mozilla 6.0+ browsers.

One approach to identify an accurate value for the maximum amount of data that a client can send to a server is to directly measure the amount at least one time at the beginning of each unique client session. To achieve this, begin by sending a known large amount of data (larger than the client can send to a server) from the client to a server. Then set up a loop that each time sends a slightly smaller amount of data from the client to a server. When the server receives all known data from a client, then that value is the maximum amount of data that the specific client can send to a server. This maximum data send size can be stored in a cookie or with client session data so that the maximum send data only needs to be measured once per client session.

Once the maximum amount of data a client can send to a server is known (measured or assumed based on specs), sending any amount of data from a client to a server can be automated. If the amount of data that the client needs to transfer to the server is larger than the maximum allowed for a URL (HTTP GET), then the data is broken up into smaller blocks that can each fit in the URL and sent to the server one block at a time. When a server receives a block of data, it is stored and a response is sent back to the client asking for the next block. This loop continues until the server receives all the blocks of data. Once all data is received, the server assembles all the individual data blocks back into the original data, processes the client data (including any RPCs), and returns the final response to the client. This approach allows the client to upload any amount of data to a server before the server processes the data and responds, and the unrestricted client-to-server data transfer process can be implemented as an automated backend scripting process.

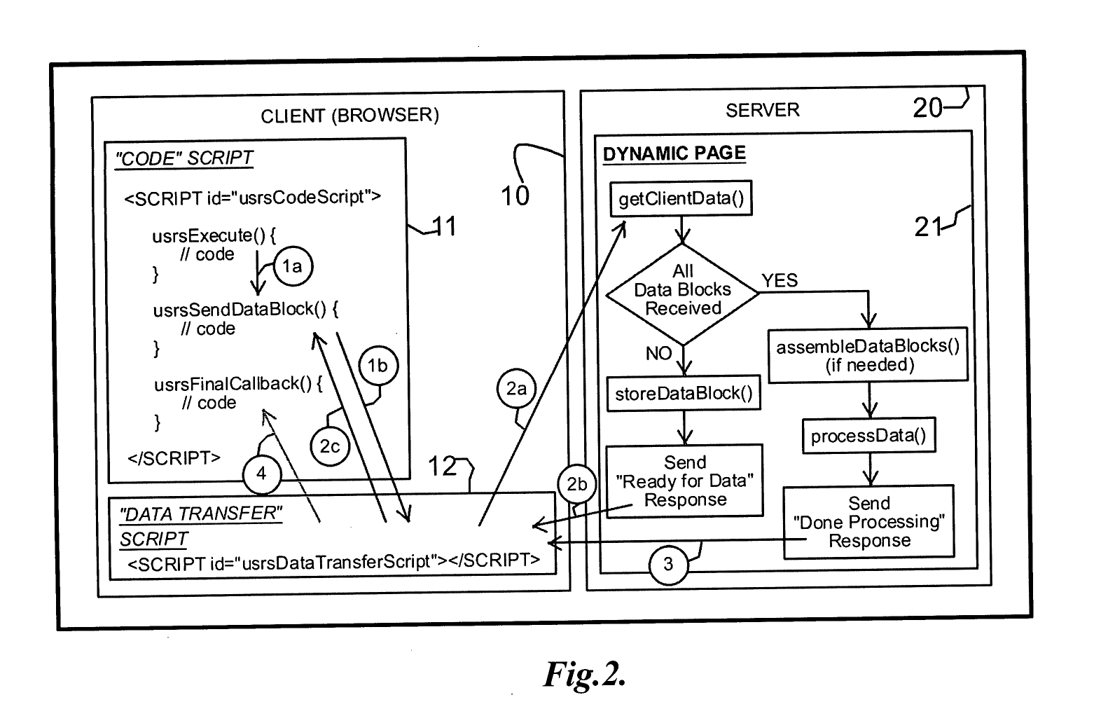

FIG. 2 is a block diagram illustrative of an architecture for implementing unrestricted, symmetric remote scripting in accordance with an embodiment of the present invention. As illustrated in FIG. 2,

1a. The client (10) executes a JavaScript (11) call to usrsExecute, which begins the process by initializing the system (including determining how much data can be sent to the server as part of the query string) and then calling usrsSendDataBlock to send the first block of client data.

1b. The usrsSendDataBlock function extracts the next block of send data (based on the maximum query string size) from the complete raw data that needs to be sent to the server (20). If all the data (or the last block of data) is about to be sent, then an “all data sent” flag is also passed to the server (20). The usrsSendDataBlock function then sets the SRC attribute of the “data transfer” script (12) to the correct server URL (the query string includes the block of data as well as any other flags and variables that need to be sent to the server).

2a. The “data transfer” script (12) sends a request (using HTTP GET) to a dynamic server page (21) on the server (20). The dynamic server page performs the following general actions. The first method (getClientData) receives the client data and parses the query string to extract the data and flags. If all the data has not been received from the client (10), then the server (20) stores the current block of data and processing continues with Step 2b. If the server (20) did receive all the data from the client (10), the server (20) assembles (assembleDataBlocks) all the data blocks back into the original raw client data. The server then processes the complete client data (processData), and finally processing continues with Step 3.

2b. When the server (20) has not yet received all the data from the client (10), it returns a “Ready for Data” response and continues processing with Step 2c.

2c. When the client (10) receives a “Ready for Data” response from the server (20), the usrsSendDataBlock function is called to send the next block of data to the server and processing continues with Step 1b. This looping (Step 1b to Step 2a to Step 2b to Step 2c to Step 1b . . . ) continues until all the original client (10) data is sent in blocks to the server (20). Once the server receives all the blocks of client data (getClientData), it assembles the data (assembleDataBlocks), processes the data (processData), returns a “Done Processing” response, and finally processing continues with Step 3.

3. When the server (20) receives all the client (10) data and finishes processing the data, it sends the client a “Done Processing” response.

4. The server (20) response contains JavaScript code that runs as a new “data transfer” (12) script on the client (10). The server (20) response can contain any needed combination of JavaScript variables with server data, server generated JavaScript functions and calls, and a call to a callback function that continues some pending or new processing in the client-side “code” (11) script.

Applications and Uses

In an illustrative embodiment of the present invention, applications that rely on Remote Scripting can readily be adapted to use the present invention. In addition to offering significant improvements to existing Remote Scripting applications, the present invention also enables a broad array of new capabilities. Unique uses range from new or enhanced features for existing products and services to completely new products and services that are currently not possible. Many of the unique uses and applications that are possible with the present invention can be grouped into four general categories: (1) data streaming, (2) data display, (3) data sharing, and (4) remote application sharing. Representative examples of unique applications that use the present invention are as follows:
1) Data Streaming

The present invention can be used to enable a variety of clientless (all HTML) multimedia and data streaming applications some of which are currently only possible using specialized clients like Java, ActiveX, and Flash. Some examples of unique uses that primarily rely on the data streaming capability of the present invention are as follows:

a) Client Contextual View

A contextual view of a client (browser) page is an exact server-based copy of the original client page that is still dynamically linked to the original client. As a user does anything or makes any changes in the original client page (such as typing characters into a form element, moving a cursor, etc), the changes are automatically displayed in the server-based contextual view of the client page. In essence, a contextual view contains all the detailed context of what is occurring in real-time in a remote client page.

Any enabled client (browser) page can send a dynamic contextual view of the client page to a server. The first step is to send the complete client page to the server when the client page loads. Since client code runs when a client page loads, the client code reads the client HTML directly from the DOM (Document Object Model) and then writes the client page data to the server. Once the complete client page is sent to the server, any client-side changes that occur are automatically sent to the server and merged with the complete client page. A complete client page can be sent each time a client change occurs, but it uses much more bandwidth and time than just sending the changes and then merging the data on the server. At any given time, the contextual view of the client page that is stored on the server is identical to the original page that is loaded in the client (browser). More than being an identical copy of the client page, the contextual view can contain anything that can be accessed through the client-side DOM such as characters that are entered into form elements, where the cursor is located, etc.

The present invention can use a number of possible approaches to send real-time client changes to the server. The simplest approach is to set the client code to automatically send data to the server in response to appropriate client-side DOM events such as cursor movements, keystrokes, mouse clicks, a form field loses focus, window state changes, etc. Beyond just responding to client events, the present invention can also set up a persistent client/server loop (continuous, periodic, or aperiodic) such that each loop causes the client to send details about the current client state to the server. Information sent about the client state can include anything accessible through the client-side DOM.

A server-based contextual view is a desirable feature for a number of commercial applications such as co-browsing, live support, usage monitoring, online training, etc. Specialized clients (like Java and ActiveX) fail to offer a true server-based contextual view, because security restrictions limit the usefulness of such a solution. Specialized client applications like Java and ActiveX (typically an invisible Java applet is used) can access the DOM of the client page they are embedded in and then send that data to a server using a client/server connection; however, for security reasons these action require user permission. Before a specialized client like Java or ActiveX can access the page DOM and send it to a remote server, a user will typically have to click an OK button on a Security Alert dialog that asks if the embedded client can do the requested action. In general, security restrictions prevent specialized clients (like Java and ActiveX) from generating a useful server-based contextual view.

When opened in a client (browser), the contextual view can include enough detail to look exactly like the original client (including showing characters typed into form elements as they are being entered, displaying an image that shows the cursor movements in the original client, etc.). In the extreme case where all client changes are sent to a server in real-time, the contextual view would include real-time details about everything a user is doing in a client page.

b) Real-Time Client Usage Monitoring

In accordance with another aspect of the present invention, given a server-based contextual view of a client page, generating detailed and useful real-time usage data about a client reduces to a simple task of intermittently (continuous, periodic, or aperiodic) saving a copy of the server-based contextual view. Any general data associated with the contextual view can also be saved including a timestamp for the saved data, a unique client session identifier, the client page URL, HTTP referrer fields, HTTP headers, cookies, etc. If all contextual view data is saved, then a slideshow-like playback of the saved usage data will look identical to original client session including displaying anything described above for a contextual view (such as displaying text that is entered into form elements, showing cursor location, etc.). If timestamps are used to synchronize an automated playback of saved usage data, then it would look like an exact video reproduction of the original client session including displaying text in form fields when they were entered (or corrected), displaying cursor movements and actions when they occurred, etc.

Using <IMG> tags with invisible images is a simple form of Remote Scripting that is typically used to generate client usage data. Two major problems with this and other usage monitoring methods are that they require a user action (like a page load or a button click) to transmit data and they provide a static timestamp that some specific event occurred (like a button click, an image load, or a page load). In addition, the most valuable usage data, which generally occurs just before a client session ends, is often lost. The client session ends when the client is closed, the client opens a new site URL, a client error occurs, etc. Since a user often will never click on an active element on the last client page that is viewed, no usage timestamp is typically available for the last page a user views in a client session (other than possibly the page load timestamp). Even if a timestamp was sent for the last page in the client session, it does not really provide much useful information such as what problem the customer may have had, what error may have occurred, what the customer was doing just before the session ended, etc. In general, existing usage monitoring technologies and methods produce limited usage data (mostly static timestamps based on client events) that cannot be used to accurately reproduce or analyze a client session.

As discussed above, the contextual view includes much more detailed real-time information about a client. Therefore, any real-time usage monitoring based on the present invention will generate far more useful and detailed information than is possible with other technologies or methods. In the extreme case, usage data can be used to generate an exact slideshow of everything that occurred in the original client page. The usage data also includes data up to the moment a client session ends (client page closes, client error occurs, etc.). This means that usage data can be used to perform very detailed analysis of site usage ranging from assessing technical and performance problems to studying very complex and subtle site usability issues.

c) Multimedia Streaming

In general, the present invention can be used as a secure, clientless (all HTML) alternative for streaming any type of digital data (including all formats of multimedia data, streaming cams, audio, video, voice/VoIP, etc.) between a client and server. One use for the streaming capability of the present invention is to provide a clientless client/server connection that can be used by any client-side multimedia or data streaming application that needs to communicate with a remote server (such as media players, browsers, multimedia browser plug-ins, cams, voice/VoIP clients, etc.). When used in conjunction with the present invention, the client-side application would provide the desired functionality (such as display streaming cam images or convert VoIP data to audio) and the preset invention would provide secure, clientless communication and data transfer between the client and server.

2) Data Display

In accordance with another aspect, the present invention generates and sends a complex, secure visual display and UI (user-interface) to a client. The present invention achieves this by using client-side DOM properties, methods, and/or event handlers to directly set, create, and/or replace anything within a client (browser) page. Since the response returned by a server to a client immediately runs as new client-side code (such as with the “dual script” embodiment described above), the server response simply needs to contain DOM calls that directly populate the client DOM tree in order to modify a client display.

In general, the server response can include commands that directly (and in real-time) perform any one of the following actions:
Add a New Element to the Client DOM Tree—the present invention can directly add (in real-time) any supported DOM element as a new node to the client DOM tree. Examples include adding multimedia elements (<IMG>, embedded video & audio, embedded clients like Flash, etc.), layout elements (<DIV>, <SPAN>, <FONT>, <TABLE>, etc.), and active elements (<EMBED>, <SCRIPT>, <APPLET>, <OBJECT>, etc.).
Modify Any DOM Element Attribute—the present invention can directly modify (in real-time) the attribute of any supported DOM element (or node, child node, etc.).
Modify Any DOM Element Content—the present invention can directly modify (in real-time) the content of any supported DOM element (or node, child node, etc.).
Restructure the DOM Tree—the present invention can directly move, reposition, or restructure (in real-time) the complete client DOM tree as needed to position any element (or node, child node, etc.) on a client page.

The ability for the present invention to directly restructure and populate the DOM of a client in real-time allows it to generate very dynamic, interactive, and secure visual client (browser) user interfaces. Some examples of unique uses that primarily rely on the data display capability of the present invention are as follows:

a) Secure Client Display

In addition to generating a complex, interactive real-time client display and UI (user interface), the present invention can also create a completely secure client. When data is sent to/from a secure client page, the data transfer can be protected by some form of encryption (SSL, PGP, PKI, etc.); however, even with encrypted data transfer, sensitive data could still be left in the local browser cache in plain text (not encrypted). The local browser cache represents a major security hole that cannot be solved by other technologies or methods. Not only does the present invention eliminate this local browser cache security problem but also it does so within any client page technology (HTML, ASP, ASPX, JSP, PHP, etc.).

The way the present invention achieves this is by directly populating the DOM of a web page that contains secure or sensitive data. The first step is to have the client load a URL for a general page template that contains everything except the secure data (i.e., site header, footer, navigation bars, general content, etc.). The present invention then adds any secure data to the general client page template by directly populating its DOM. Any page data can be securely sent (encrypted) from the client to the server using a standard form submit (HTTP GET or POST) or using the present invention. Any secure or sensitive data that needs to be returned to a client is sent using the present invention, which again directly populates the client DOM with the data.

As soon as a client (browser) page closes, all the data sent by the present invention to the client is erased from memory (i.e., not stored in the local browser cache). The data stored in the local browser cache is the general site template that was first displayed when the page loaded (before any secure data was sent and displayed by the present invention).

b) Rich Media Marketing

One approach that the present invention can use is to create a “pop-in” window for displaying Rich Media ads. The present invention can dynamically add a floating <DIV> element to a client page (or use any other type of relative or absolute positioning that is possible with a <DIV> element). Since a pop-in window is integrated in the actual client page, it cannot be blocked or stopped by any pop-up ad blocker or other security measures. In essence, it is not possible to distinguish the pop-in window from the client page. The same applies if the main client window is used to hold the Rich Media ads instead of using a specialized pop-in window.

Given a window for holding Rich Media content (such as a pop-in window or the main client window), the present invention has a number of options for populating the window with a broad array of multimedia and dynamic content. One option is to dynamically add (or set) multimedia elements. For example, any number of image (<IMG>) elements can be added, removed, or changed in real-time by the present invention. The SRC (source) attribute of these <IMG> elements can be set to a static image file or a dynamic server URL that generates the image in real-time. Similarly, any number of other multimedia (audio, video, etc.) or visual (text, lines, etc.) elements can be simultaneously added, remove, or changed in real-time as needed to create a complete multimedia presentation. Embedded elements (like Flash, Java, ActiveX, etc.) can also be added or controlled in real-time by the present invention. In general, this approach involves using the present invention to set and control multiple DOM elements as a way of creating a dynamic Rich Media ad or presentation.

Another option the present invention has for populating a Rich Media window is to directly stream data from the server to client and then directly add that content to the DOM. This approach works well for text and other non-multimedia content that can be directly added to a DOM. For example, the present invention could periodically send news headlines or stock prices to a client and then direct display that data in something like a streaming news or stock ticker. A third option the present invention can use to populate a Rich Media window is to stream JavaScript code to the client that then creates the multimedia ad or presentation. This approach has the advantage of allowing customized Rich Media ads or presentations to be created in real-time for a specific individual (or a select group of individuals).

Without using any type of specialized client, the present invention can populate a client window (either the main client window or any number of pop-in windows) in real-time with a broad array of Rich Media (or any other) content. In general, the present invention is the first technology that can create a very dynamic, real-time (all content is controlled by the present invention in real-time) Rich Media ad or presentation without using any specialized clients and in a way that cannot be blocked or filtered.

c) Multi-channel, Multimedia Client Display

In accordance with a further aspect of the present invention, Rich Media Marketing use discussed above can be easily extended to multiple independent channels all running in the same client page (or any number of “pop-in” windows). The present invention is able to initiate and control any number of independent connections between a client and server. One way that the present invention can achieve this is by creating multiple “data transfer” scripts that are all controlled by at least one “code” script. Basically this is an extension of the “dual script” configuration with multiple, independent “data transfer” scripts (it is very much like spinning multiple independent client-side code threads as needed to multi-process a particular task). The present invention can simultaneously create and coordinate multiple Rich Media ads or presentations within a single client window.

3) Data Sharing

Since a server coordinates all interactions with enabled clients, sharing data between different client sessions is a relatively straightforward process of sending shared server data to the correct clients. In contrast with specialized client/server applications that can also share server data, when data sharing is combined with other clientless capabilities of the present invention like data streaming and data display, the present invention can be used to implement numerous clientless data sharing applications. Some examples of unique uses that primarily rely on the data sharing capability of the present invention are as follows:

a) Co-Browsing

Many existing products, services, and technologies claim some type of co-browsing functionality; however, none can actually accomplish true co-browsing. For example, using a URL push to simultaneously send all individual co-browse clients to the same web page works for simple web sites, but it will not work for dynamic, session-dependent sites (i.e., sites where the content displayed on a page depends on previous pages that were viewed or on content that was entered). Using a specialized client (such as Java or ActiveX) to create a co-browsing session that is shared by more than one individual requires all users to load the same specialized client (in addition to programs such as the operating system and browser) and in essence log into the same session that is then simultaneously displayed in all co-browse clients. This is not really co-browsing but is application sharing that often requires special system privileges for client installation (such as with web conferencing applications). In addition, it is very difficult or impossible to share session data (like cookies) that is needed to co-browse session-dependent sites. In general, other technologies fail to allow more than one person to simultaneously co-browse web sites using standard browsers without any specialized co-browse clients.

In accordance with an aspect, the present invention extends the contextual view described above, which covers a method for storing an exact, active server-based copy (or contextual view) of any client page. In essence, to accomplish co-browsing, multiple clients simultaneously share the same server-based contextual view. Any individual co-browse client is able to modify the shared server-based contextual view and then the server propagates out any contextual view changes to all affected co-browse clients.

The above contextual view use section describes how to store a contextual view on a remote server. Here it is described how a server-based contextual view can be viewed. One way to view a server-based contextual view is to use a dynamic server URL. Simply pass a unique session ID (i.e., the unique ID for the contextual view being requested) to the server as part of the URL query string, and the server would then return (as the HTTP response) the corresponding server-based contextual view as a complete HTML page. If the URL is entered into a browser, then the browser will display the contextual view page (i.e., an exact, active copy of the original client page). In order for a server to control and interact with a displayed contextual view page, when the page is loaded it is initialized as a unique client session that is controlled by the same sever system that stores the server-based contextual view data. This allows the server to easily collect real-time contextual view data from the original client and then immediately send (in real-time) any changes to all open contextual view pages. Co-browsing is a simple extension of this process for displaying a contextual view page where any co-browse page (the original client and all open “client view” pages) can change the server-based contextual view before the changes are sent to all affected clients (including the original client).

The present invention can use a number of different approaches for dealing with complex, session-dependent sites. One approach is to directly share session data. Since the present invention completely controls each client, it is possible for the present invention to access and modify hidden session-dependent client data such as cookies. Therefore, a server-based contextual view can include cookies and other required session data that is used by all co-browse clients. Under some conditions, sharing cookies (and other hidden session data) can cause problems by incorrectly over-writing any pre-existing cookies (or other session data) in the co-browse clients.

An alternative approach that eliminates this potential problem is to designate a master co-browse client (typically the first co-browse client to load) and then synchronize all other slave co-browse clients to the one master client. This master/slave co-browse approach works with any type of session-dependent site because the master client is the only client that needs correct session-dependent data (such as cookies). All web navigation is done by the master client, which then updates the server-based contextual view that is propagated to all associated slave clients. If an action is performed on a slave client, then it does not directly process the action. Instead, the slave client sends the necessary data to the server, the server then populates the master client with the data and causes the master client to process the action, and finally the master client updates the contextual view before it is sent to all the slave clients. In essence, the master client does all the web navigation and all slave clients are synchronized to the contextual view generated by the master client.

b) Interactive Form Sharing

Interactive forms allow two or more people to simultaneously view and complete a web form (including multi-page forms), and they are commonly sold as part of an online Live Support product of service. A number of commercial products and services claim to offer interactive forms; however, for similar reasons to those discussed in the co-browsing section, none are true interactive forms. The present invention is the first technology that is capable of producing true interactive forms that work for any web form and on any browser (without any type of specialized interactive form sharing client).

One difference between co-browsing and interactive form sharing is the real-time resolution. For co-browsing, data generally is synchronized after a page is loaded or refreshed. For interactive form sharing, data is synchronized after each form action such as when text is entered into a form field, when a form element loses focus, etc. The intention with interactive forms is to allow everyone sharing the form to see in real-time every action being done by every user. As detailed above, the present invention has the unique ability to send a tremendous amount of detail about what is happening in real-time in a client.

c) Collaboration, Conferencing, and Data Sharing

Online collaboration occurs in many different ways but generally falls into the following general categories: collaboration, conferencing, and data sharing. Existing collaboration and conferencing products (such as from WebEx; www.WebEx.com) generally offer two different conferencing clients: a full client that requires admin privilege to install and a limited client (typically Java) that works in a browser without requiring any special installation privilege. The full client is able to offer all the interactive functionality commonly associated with conferencing such as whiteboarding, data sharing, application sharing, etc. The limited client is essentially an enhanced viewer that allows much of a conference to be passively viewed but generally does not allow any interactive conferencing functionality like whiteboarding, data sharing, application sharing, etc.

One reason that two different clients (full and limited) are offered by existing conferencing products and services is because many users do not have the admin system privilege required to install the full conferencing client. This is because a full conferencing client represents a major security risk. A full conferencing client is equivalent to a Desktop Terminal Services client that allows remote access and control of a remote desktop. It is mainly this ability to remotely control any computer with the full conferencing client installed that allows the full client to offer functionality like interactive whiteboarding, data sharing, and application sharing. Since the full conferencing client is typically accessed online, it can provide a way for a hacker to attack, access, and control any computer that has installed a full conferencing client. For this reason, many corporate users will never have the admin system privilege needed to install a full conferencing client. This restriction significantly limits the usefulness of existing conferencing products and services for a large majority of corporate users. Even users that have admin permission will often not install the full client because of the serious security risk. In general, the security risks associated with all existing full conferencing clients limit their use to a relatively small part of the total potential conferencing, collaboration, and data sharing market.

Conferencing based on the present invention enables much of the functionality possible with Desktop Terminal Services clients (see the below Remote Application Sharing section) without using any type of specialized client. Since the present invention does not use a specialized client, nothing needs to be installed on the client and therefore no special system privilege is needed to use conferencing. In addition, the present invention is much more secure than other technologies because it uses no specialized client that can be attacked and it is not vulnerable to DOS (denial-of-service) and other network attacks.

Functionality like whiteboarding and data sharing are just extensions of the Interactive Form Sharing use discussed above. In general, once the present invention controls a client, it is straightforward to stream any type of data between a client and server. In addition, once a server receives and stores client data, it can readily share the data with any active client. To enable whiteboarding, the easiest approach is to use the present invention to track any changes in a graphical (whiteboard) area of a client page and send any whiteboard changes to a server, which then propagates the changes to all affected clients. Another approach is to overlay whiteboard markings on top of an image and then synchronize that image (including the whiteboard overlay) with all affected clients.

How data sharing is enabled largely depends on the type of data. If it is simple data like ASCII text data, then it just becomes a data channel that is shared between all affected clients. If it is application data (such as PowerPoint, Excel, etc.), one approach is to use a remote server application to process all shared data (see the below Remote Application Sharing section for details), which is then sent to each client that is sharing the data. Any data changes that occur on a client are sent to the server-based application and then synchronized with all affected clients. A number of options are available for displaying shared application data on a client. One option is to create an all HTML interface that can display the data. In this case, the DOM of the client (browser) page is directly populated with the formatted data in a fashion similar to the methods described in the above Data Sharing section. Another option for displaying application data is to send the data to the client in its native file format, which then automatically opens the application on the client computer (if it is installed). For example, if native Excel data is sent to a client, the data MIME type will insure that Excel is used to open and display the data on the client computer. In general, data sharing based on the present invention involves sending data changes from a client to a server, processing the server-based data, sending the data from a server to all clients that are sharing the data, and displaying the data on the clients.

In one embodiment, to enable remote application sharing, the present invention uses a similar approach to data sharing (see the below Remote Application Sharing section for details). In general, the present invention can do more than possible with any other full conferencing client, and the present invention does not use any specialized clients (i.e., the present invention does not require any special system privilege to use it). This means that collaboration, conferencing, and data sharing based on the present invention can be used by a much larger market segment than is possible with other collaboration technologies or methods.

d) Messaging

Many different forms of messaging (instant messaging, universal messaging, enterprise messaging, chat, etc.) have been developed and deployed, and nearly every useful messaging implementation uses some type of specialized client technology or programming language (Java, ActiveX, C/C++, ASP, etc.). A few script-only (primarily JavaScript) chat and messaging implementations are available, but they are generally limited to simple text chat functionality and often cannot be easily scaled for use with large sites. The present invention is the first clientless messaging technology that offers all the functionality available today with specialized client messaging technologies. In addition, the present invention extends to messaging all the general benefits discussed above as well as enabling a number of advanced messaging features that are far beyond anything that is possible using messaging technologies or methods.

A messaging window can be readily added to any HTML page. Alternatively, a pop-in window (such as described in the above Rich Media Marketing section) can be used for messaging. From the perspective of the present invention, messaging just represents a simple data channel that involves three tasks: (1) transferring data between a server and a client, (2) performing some server processing and synchronization, and (3) displaying (or playing for audio, video, etc.) the messaging data in the client. The overall messaging process is very similar to the description given above in the Collaboration, Conferencing, and Data Sharing section.

Originally, messaging applications were created and deployed as a way for a group of remote individuals to communicate (typically using text or html messages) in real-time with anyone in the group that is connected to the Internet. At present, messaging is rapidly evolving for use as a real-time enterprise communication tool. As part of this transition to enterprise messaging, existing messaging technologies are struggling to adapt to meet the much more demanding standards required for use with enterprise messaging.

The present invention can offer all the functionality desired for a complete enterprise messaging platform. Examples of messaging functionality that is possible using the present invention is summarized in the following list:
Complete Session Audit Trail—since a server processes and manages all shared data, creating a complete messaging session audit trail is a simple process of saving the messaging data sent to a server. In addition to saving an audit trail with data that is sent to the server, the present invention can create a much more detailed audit trail than is possible with other technology. Specifically, the present invention can include details about everything that happens in a client (separate from the data a client sends to the server). In essence, the present invention can include the contextual view for each client as part of the audit trail. As discussed above, the contextual view can include real-time information like text that is entered (or modified) in form elements, cursor movements, etc. The present invention can include real-time details about client actions as part of a session audit trail.

Secure Data—as discussed in the above Secure Client Display section, it is easy to securely transmit data across a network using a variety of encryption methods (SSL, PKI, etc.); however, the present invention is able to securely display data in a browser. In particular, the present invention eliminates the local browser cache security hole that cannot be eliminated other technology. As a result, messaging can be used to display sensitive data in any type of client page (including HTML forms), and the present invention exceeds even the most rigorous security standards covering government regulated data such as HIPAA, financial data, etc.

Multimedia and Rich Media Compatible—as discussed in the above Rich Media Marketing section, the present invention can readily display or play (at design time or dynamically at run time) any type of multimedia and Rich Media data in a messaging window.

Integrated Conferencing, Collaboration, and Data Sharing—as discussed in the above Collaboration, Conferencing, and Data Sharing section, the present invention can readily add (at design time or dynamically at run time) a broad array of advanced conferencing, collaboration, and data sharing functionality directly to any messing window.

Remote Applications—as discussed in the below Remote Application Sharing section, the present invention can be used as a clientless interface for a variety of server-based applications. Any server-based application can be directly added (at design time or dynamically at run time) to a messaging window.

Multiple, Independent Data Streams—as discussed in the above Multi-channel, Multimedia Client Display section, the present invention can add (at design time or dynamically at run time) any number of independent data channels to a messaging window. Each independent data channel can contain any type of data supported by the local computer such as text, graphics, multimedia (video, audio, voice/VoIP, etc.), application data (Excel, PowerPoint, etc.), etc.

The present invention can extend far beyond just messaging into interactive rich media messaging and collaboration. Within a single HTML page (or pop-in window), the present invention can include multiple independent data channels such as a channel with messaging (text, video, audio, voice/VoIP, etc.), a second channel with a rich media presentation, and a third channel with a shared whiteboard. Any desired configuration of communication and collaboration channels can be readily added as needed to a messaging window (at design time or at dynamically at run time).

4) Remote Application Sharing

As detailed in the above Data Streaming, Data Display, and Data Sharing sections, a client is a very secure and efficient front end both for communicating with a remote server as well as for displaying and sharing server-based data. In essence, the present invention is a clientless technology that offers all the client/server and UI (user-interface) functionality currently requiring specialized client technologies like Java, ActiveX, Flash, etc. As discussed above, the present invention offers far more functionality than is possible with other client/server technologies. This secure and efficient front-end display and communication capability readily extends to a broad range of uses involving remote application sharing. Some examples of unique uses that primarily rely on the remote application sharing capability of the present invention are as follows:

a) Remote Mainframe Access—many legacy mainframe computer systems are currently being used to store large amounts of important corporate and government data, and these remote mainframe hosts are continually being accessed using some variation of a terminal emulator. All other terminal emulators generally fall into two general categories: specialized client terminal emulators and all HTML terminal emulators. Specialized client (Java, ActiveX, stand-alone app, etc.) emulators allow efficient communication with a host as well as good UI and graphics flexibility (even if just an enhanced “green screen”). The “all HTML” emulators work on any web-enabled device that supports HTML, but they are not true emulators. Instead, all other “all HTML” emulators are crude and inefficient front-end interfaces for server-based terminal emulators. To communicate with a remote host, an “all HTML” emulator needs to do a form submit (HTTP GET or POST). This form submit causes a remote server to perform the requested remote host action and then return a full HTTP response (i.e., return a complete formatted HTML page) to the client (browser) that made the original request. The combination of poor UI and inefficient communication limits the general use of other “all HTML” emulators. Despite the many disadvantages discussed above for specialized client applications, a specialized client terminal emulator is almost universally used for remote host access unless an application absolutely requires an “all HTML” emulator implementation.

The present invention can produce a clientless terminal emulator with all the UI flexibility and network communication efficiency currently offered by other specialized client emulators. One emulator approach is to use a server-based terminal emulator application that starts an independent instance of an emulator object for each unique client session being managed by the server. This approach allows very efficient network communication. Instances of the server-based emulator application maintain active connections with a remote host mainframe. Since the server can be located behind a firewall, the connection between the server and remote hosts can be very fast and secure (much more secure than possible with other emulators). A client can efficiently send to the server just the data needed to control the emulator instance associated with the client session. In addition, the response directly populates the client DOM (see the Data Display section above for details), which allows the present invention to return only needed HTML data in the response (instead of a full formatted HTML page with other “all HTML” emulators). Another benefit is that any real-time data generated by the host can be directly sent to and displayed in the client, which is not possible using any other “all HTML” terminal emulators. This combination of efficient client/server communication together with efficient and flexible UI allows the present invention to offer a clientless terminal emulator with all the performance and flexibility of a specialized client emulator. In addition to offering all the general benefits discussed above for the present invention, an emulator based on the present invention is clientless and works in any web-enabled device that supports HTML.

b) Clientless VPN (Virtual Private Network)—this is a simple extension of the description given above for Remote Mainframe Access where a server-based emulator application is replaced by a server-based VPN application. A server runs the VPN application, which is configured to securely access remote networks. Any client can then be used to securely access and control its associated VPN instance on the server. This allows the present invention to be used as an efficient clientless VPN for securely accessing a remote network from any web-enabled device.

c) Clientless Desktop Terminal Services (DTS)—this is a simple extension of the description given above for Remote Mainframe Access where a server-based emulator application is replaced by a server-based DTS application. A server runs the DTS application, which is configured to securely access and control remote computer desktops. Any client can then be used to securely access and control its associated DTS instance on the server. This allows the present invention to be used as an efficient clientless DTS application for securely accessing and controlling any remote computer desktop.

d) Enterprise Application Integration (EAI)—this use extends a simple, efficient clientless interface of the present invention to any combination of server-based applications. The main purpose of EAI is to allow all users on a network to share remote server-based application resources (typically though some type of a web interface) as required to complete any tasks the users need to accomplish. The shared server-based applications can range from generic or custom applications to commercial applications like Word, PowerPoint, or Excel from Microsoft. For many of the same reasons discussed in the above Remote Mainframe Access section, existing enterprise-level EAI products are limited to using some type of specialized client technology (Java, ActiveX, C/C++, etc.). The present invention is the first clientless technology or method that offers all the same functionality possible with other EAI technologies. Since the present invention uses no specialized clients, it works on any web-enabled device. In addition, the present invention can simultaneously generate and manage multiple, independent data streams, which means that the present invention can produce a single integrated clientless interface for a broad range of EAI applications.

While illustrative embodiments of the invention have been illustrated and described, it will be appreciated that various changes can be made therein without departing from the spirit and scope of the invention.

1. A method for creating a network connection between a network connected application and a server, the method comprising:
obtaining a network request from the network application;
transmitting to the network application information corresponding to the network request, wherein the information includes at least one instruction for transmitting a subsequent request to the remote server;
obtaining a subsequent network request from the network application corresponding to the at least one instruction; and
establishing a persistent connection with the network application.

2. The method of claim 1, wherein the network request is transmitted from a protocol selected from a group consisting of TCP/IP protocols (TCP, UDP, etc.), VoIP protocols (RTP, RTCP, etc.), cellular protocols (GPRS, CDMA, WAP, etc.), and general protocols (Frame Relay, ATM, etc.).

3. The method of claim 2, wherein the persistent network connection is not limited to a single network domain or IP address.

4. The method of claim 3, wherein the network application does not require a specialized client technology.

5. The method of claim 4 further comprising permanently archiving any of the data and requests that are transferred between the network application and the server.

6. The method of claim 5 further comprising establishing multiple, independent network connections between the network application and the server.

7. The method of claim 6, wherein the network application controls the persistent network connection.

8. The method of claim 6, wherein server controls the persistent network connection.

9. The method of claim 1, wherein the network includes a LAN (Local Area Network).

10. The method of claim 1, wherein the network includes a WAN (Wide Area Network).

11. The method of claim 1, wherein the network request is a simple HTTP GET request.

12. The method of claim 1, wherein data and instructions are only sent from the network application to the server.

13. The method of claim 1, wherein data and instructions are only sent from the server to the network application.

14. A method for creating a network connection between a browser and a server, the method comprising:
obtaining a connection request from the browser;
transmitting to the browser information corresponding to the network request, wherein the information includes information for transmitting a subsequent connection request to the remote server;
obtaining a subsequent connection request from the browser corresponding to the information for transmitting a subsequent connection request to the remote server; and
establishing a persistent connection with the browser.

15. The method of claim 14, wherein connection request is transmitted via a protocol selected from a group consisting of TCP/IP protocols (TCP, UDP, etc.), VoIP protocols (RTP, RTCP, etc.), cellular protocols (GPRS, CDMA, WAP, etc.), and general protocols (Frame Relay, ATM, etc.).

16. The method of claim 15, wherein the persistent network connection is not limited to a single network domain or IP address.

17. The method of claim 14, wherein the browser does not require a specialized browser technology, such as ActiveX, Java, and Flash.

18. The method of claim 14 further comprising permanently archiving any of the data and requests that are transferred between the browser and the server.

19. The method of claim 14, further comprising establishing multiple, independent network connections between the browser and the server.

20. The method of claim 14, wherein the browser controls the persistent network connection.

21. The method of claim 14, wherein server controls the persistent network connection.

22. The method of claim 14, wherein the network includes a LAN (Local Area Network).

23. The method of claim 14, wherein the network includes a WAN (Wide Area Network).

24. The method of claim 14, wherein the network request is a simple HTTP GET request.

25. The method of claim 14, wherein data and instructions are only sent from the browser to the server.

26. The method of claim 14, wherein data and instructions are only sent from the server to the browser.

27. The method of claim 14, wherein the information for transmitting a subsequent connection request to the remote server includes scripting data.

28. The method of claim 27, wherein the information for transmitting a subsequent connection request to the remote server includes a first executable code portion and a second executable code portion for generating the connection request.

29. The method of claim 28, wherein the first executable code section dynamically generates and sends the connection request by setting the source attribute of a script tag in the second executable code portion.

30. The method of claim 28, wherein the second executable code portion dynamically generates a script source change DOM event.

31. The method of claim 28, wherein the first executable code portion and the second executable code portion dynamically determine the maximum amount of data that can be sent by the browser using an HTTP GET.

32. A system for producing a persistent network connection between any network connected web browser (Browser) and any remote server (Server), the system comprising:
a Browser that sends a dynamically generated HTTP GET request;
a first executable code portion loaded on the Browser that includes Browser scripting code;
a second executable code portion loaded on the Browser that generates and sends server connection requests, wherein the source attribute of the second executable code portion is dynamically set;
a Server that receives and processes the network request from the Browser, wherein the Server generates a response that returns to the second executable code portion data and at least one instruction to process the Browser request;
wherein the Server response also includes an instruction that causes the Browser to send a subsequent request to the Server.

33. The method of claim 32, wherein the persistent network connection is not limited to a single network domain or IP address.

34. The method of claim 32, wherein the Server permanently archives any of the data and requests that are transferred between the Browser and the Server.

35. The method of claim 32, wherein the Browser controls the persistent network connection.

36. The method of claim 32, wherein Server controls the persistent network connection.

37. The method of claim 32, wherein the network includes a LAN (Local Area Network).

38. The method of claim 32, wherein the network includes a WAN (Wide Area Network).

39. The method of claim 32, wherein data and instructions are only sent from the Browser to the Server.

40. The method of claim 32, wherein data and instructions are only sent from the Server to the Browser.

41. The method of claim 32, wherein the first and second executable code portions dynamically determine the maximum amount of data that can be sent by the Browser using an HTTP GET.

42. The method of claim 32, wherein multiple, independent network connections can be established between the Browser and the Server.
